(19) United States
(12) Patent Application Publication
(10) Pub. No.: US 2014/0020623 A1
(43) Pub. Date: Jan. 23, 2014

(54) FLUID FILTRATION

(71) Applicant: Vladimir Vinetskiy, Holon (IL)

(72) Inventor: Vladimir Vinetskiy, Holon (IL)

(21) Appl. No.: 13/550,725

(22) Filed: Jul. 17, 2012

(51) Int. Cl. B01D 33/44; B01D 33/46; B05C 11/00; B01D 37/00

(52) U.S. Cl. 118/610; 210/791; 210/355

(57) ABSTRACT

A fluid filtration device includes a housing unit and a filter member. The housing unit includes an internal chamber, an input port, a first output port, and a second output port. The input port may receive fluid into the internal chamber. The first output port may output fluid from the internal chamber received by the input port to establish a first fluid flow therein. The second output port may output fluid from the internal chamber received by the input port to establish a second fluid flow therein. The filter member may be disposed within the internal chamber to filter the fluid forming the first fluid flow.

### BACKGROUND

Fluid filtration devices may remove unwanted materials from fluids by passing the fluids through filtration media. Fluid filtration devices may be used in image forming apparatuses such as liquid electrophotography printing apparatuses, for example, to filter carrier oil to be reused therein. Carrier oil may be used in liquid toner to carry pigmented particles to be applied to substrate to form images thereon.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a block diagram illustrating a fluid filtration device according to an example.

FIG. 2 is a perspective view illustrating a fluid filtration device of FIG. 1 according to an example.

FIG. 3 is a perspective view illustrating a portion of the fluid filtration device of FIG. 2 according to an example.

FIG. 4 is a cross-sectional view illustrating the fluid filtration device of FIG. 2 according to an example.

FIG. 5 is a block diagram illustrating an image forming system according to an example.

FIG. 6 is a schematic view illustrating an image forming apparatus such as a liquid electrophotography printing apparatus including the fluid filtration system of FIG. 2 according to an example.

FIG. 7 is a flowchart illustrating a method of filtering fluid according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Fluid filtration devices may remove unwanted materials from fluids by passing the fluids through a filter member. For example, the filter member may be used in image forming apparatuses such as liquid electrophotography printing apparatuses to filter carrier oil. The filter member, for example, may include porous material to remove unwanted materials from the fluid. The unwanted materials, however, may clog the filter member. Consequently, a rate and capacity of the filter member to remove unwanted materials from the fluid may decrease. Thus, frequent replacement of the filter member may be recommended increasing the cost of a filtration operation.

In some examples, fluid filtration devices include a housing unit including an internal chamber, an input port, a first output port, and a second output port. The input port may receive fluid into the internal chamber. The first output port may output fluid from the internal chamber received by the input port to establish a first fluid flow therein. The second output port may output fluid from the internal chamber received by the input port to establish a second fluid flow therein. The fluid filtration devices may also include a filter member and a movable cleaning unit. The filter member may be disposed within the internal chamber to filter the fluid forming the first fluid flow. The movable cleaning unit may include at least one cleaning member to clean the filter member in response to engagement of the movable cleaning unit with at least one of the first fluid flow and the second fluid flow. Thus, the rate and capacity of the filter member may remove unwanted materials from the fluid and, thus, be increased. Accordingly, a number of times the filter member may need to be replaced and the cost of filtration operations may be reduced.

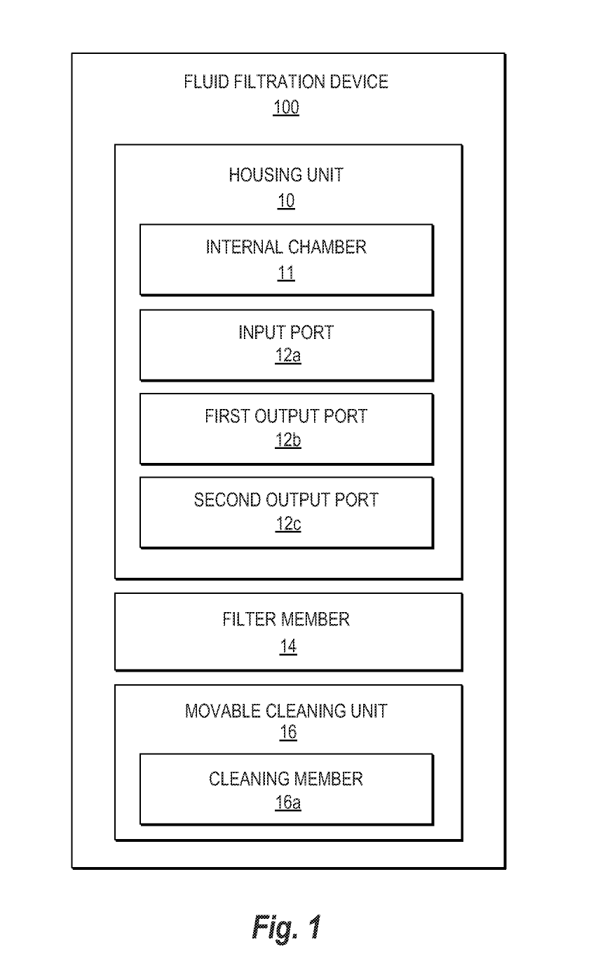

FIG. 1 is a block diagram illustrating a fluid filtration device according to an example. Referring to FIG. 1, in some examples, a fluid filtration device 100 includes a housing unit 10, a filter member 14, and a movable cleaning unit 16. The housing unit 10 may include an internal chamber 11, an input port 12a, a first output port 12b, and a second output port 12c. The input port 12a may receive fluid into the internal chamber 11. The first output port 12b may output fluid from the internal chamber 11 received by the input port 12a to establish a first fluid flow therein. The second output port 12c may output fluid from the internal chamber 11 received by the input port 12a to establish a second fluid flow therein. The filter member 14 may be disposed within the internal chamber 11 to filter the fluid forming the first fluid flow.

For example, the filter member 14 may be in a form of a mesh screen, and the like, to allow the fluid to pass through the filter member 14 while keeping unwanted material from passing the filter member 14. The mesh screen may have a porosity corresponding to a size of the unwanted material to be stopped from passing through the filter member 14. The movable cleaning unit 16 may include at least one cleaning member 16a to clean the filter member 14 in response to engagement of the movable cleaning unit 16 with at least one of the first fluid flow and the second fluid flow. In some examples, the fluid may be carrier fluid, ink, paint, and the like. In some examples, the cleaning member 16a may come in contact and be dragged across the filter member 14, for example, to clean the filter member 14, The cleaning of the filter member 15 may reduce clogs from forming and/or staying on the filter member 14.

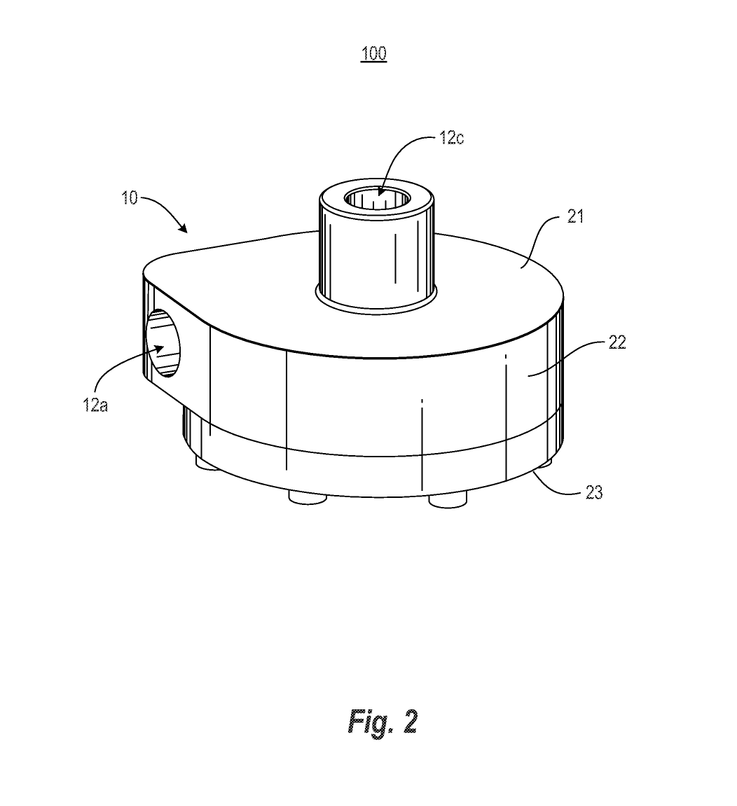

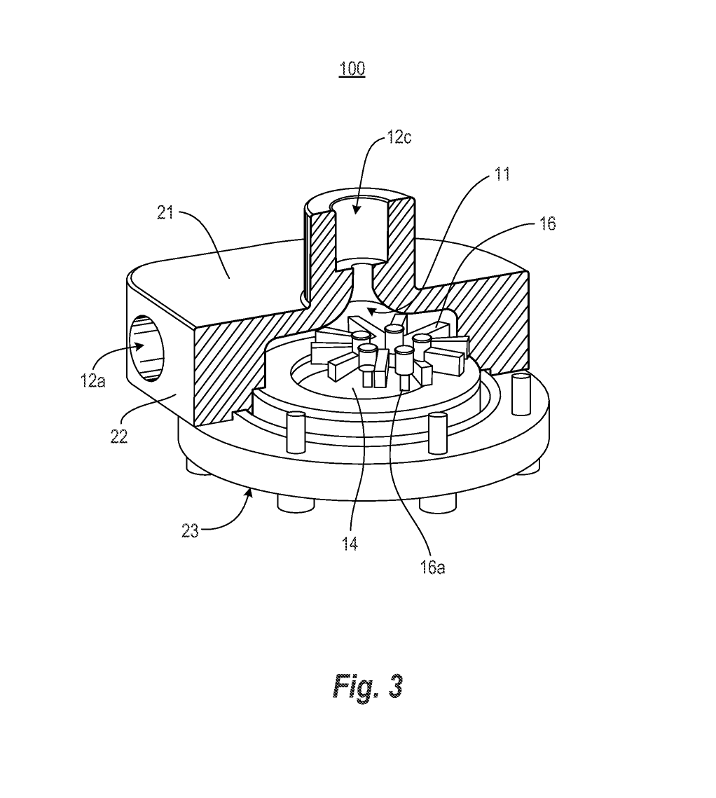

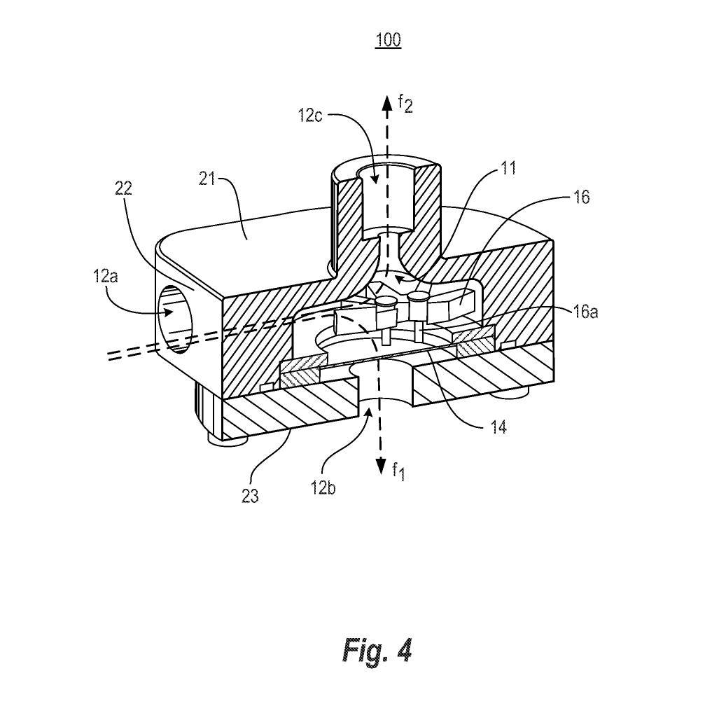

FIG. 2 is a perspective view illustrating a fluid filtration device of FIG. 1 according to an example. FIG. 3 is a perspective view illustrating a portion of the fluid filtration device of FIG. 2 according to an example. FIG. 4 is a cross-sectional view illustrating the fluid filtration device of FIG. 2 according to an example. Referring to FIGS. 2-4, in some examples, a fluid filtration device 100 includes a housing unit 10, a filter member 14, and a movable cleaning unit 16 as previously disclosed with respect to FIG. 1. The housing unit 10 of the fluid filtration device 100 may also include a top wall 21 including the second output port 12c, a bottom wall 23 including the first outlet port 12b, and a side wall 22 including the input port 12a. The bottom wall 23 may be disposed across from and substantially parallel to the top wall 21. The side wall 22 may be connected and substantially perpendicular to the top wall 21 and bottom wall 23.

In some examples, the second output port 12c may be disposed at substantially a center of the top wall 21, the first output port 12b may be disposed at substantially a center of the bottom wall 23, and the input port 12a may be disposed at the side wall 22. For example, the input port 12a may be disposed at the side wall 22 in an asymmetrical manner. In some examples, the relative positions of the input port 12a and respective output ports 12b and 12c, the direction of the fluid guided through the input port 12a, and/or the shape of the internal chamber 11, may enable turbulent flow paths within the internal chamber 11 to move the movable cleaning unit 16. In some examples, the filter member 14 may be disposed opposite to the first outlet port 12b. For example, the filter member 14 may be arranged in a horizontal manner across from the first outlet port 12b, That is, the filter member 14 may be positioned to enable fluid to pass though the filter member 14 before passing through the first outlet port 12b. Thus, the first outlet port 12b may establish the first fluid flow f₁ within the internal chamber 11 by passing through the filter member 14.

In some examples, the filter member 14 may be positioned to enable fluid to pass through the second outlet port 12c without passing through the filter member 14. That is, the second outlet port 12c may establish the second fluid flow f₂ within the internal chamber 11 by bypassing the filter member 14. The movable cleaning unit 16 may be movably coupled to the filter member 14. The movable cleaning unit 16 may move by the engagement with the first fluid flow f₁ and the second fluid flow f₂. That is, the first fluid flow f₁ and/or second fluid flow f₂ may contact and move the movable cleaning unit 16. Thus, the second fluid flow f₂ may continue and maintain movement of the movable cleaning unit 16 even when the filter member 14 may limit the first fluid flow f₁.

In some examples, the movable cleaning unit 16 may include a variety of shapes including a shape of a star, and the like. The movable cleaning unit 16 may include a rotatable brush unit 56 to rotate in response to the engagement with the at least one of the first fluid flow f₁ and the second fluid flow f₁. Additionally, the at least one cleaning member 16a may include at least one brush member 56a to brush the filter member 14 in response to rotation of the rotatable brush unit 56 by the engagement with the at least one of the first fluid flow f₁ and the second fluid flow f₂. For example, the at least one brush member 56a may include a plurality of brush members to brush the filter member 14 in response to the rotation of the rotatable brush unit 56 by the engagement of the first fluid flow f₁ and the second fluid flow f₂. That is, the brush members 56a may come in contact and be dragged across the filter member 14. The brushing of the filter member 15 may reduce clogs from forming and/or staying on the filter member 14.

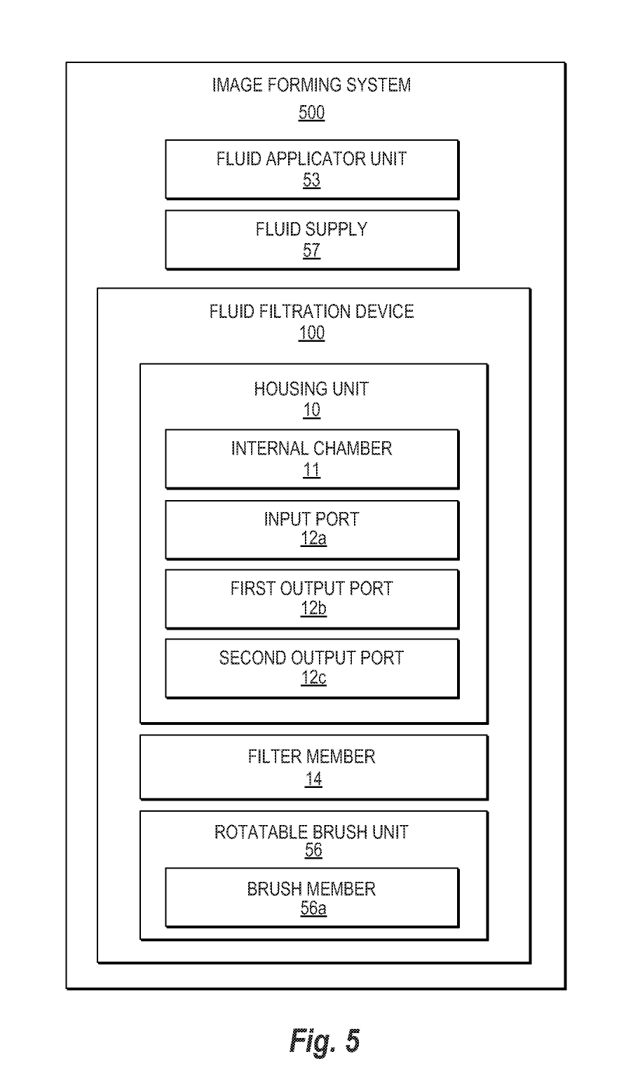

FIG. 5 is a block diagram illustrating an image forming system according to an example. Referring to FIG. 5, in some examples, an image forming system 500 includes a fluid applicator unit 53, a fluid supply 57, and a fluid filtration device 100. The fluid applicator unit 53 may apply fluid to a substrate. In some examples, the fluid applicator unit 53 may include a print head, ink developer unit, and the like. The fluid supply 57 may supply the fluid to the fluid applicator unit 53. The fluid filtration device 100 may include a housing unit 10, a filter member 14, and a rotatable brush unit 56. The housing unit 10 may include an internal chamber 11, an input port 12a, a first output port 12b, and a second output port 12c.

Referring to FIG. 5, the input port 12a may receive the fluid into the internal chamber 11. The first output port 12b may output the fluid from the internal chamber 11 received by the input port 12a to the fluid applicator unit 53 to establish a first fluid flow therein. The second output port 12c may output the fluid from the internal chamber 11 received by the input port 12a to establish a second fluid flow therein. The filter member 14 may be disposed within the internal chamber 11 to filter the fluid forming the first fluid flow. The rotatable brush unit 56 may include at least one brush member 56a to brush the filter member 14 in response to engagement of the rotatable brush unit 56 with at least one of the first fluid flow and the second fluid flow. In some examples, the rotatable brush unit 56 may include a plurality of brush members 56a.

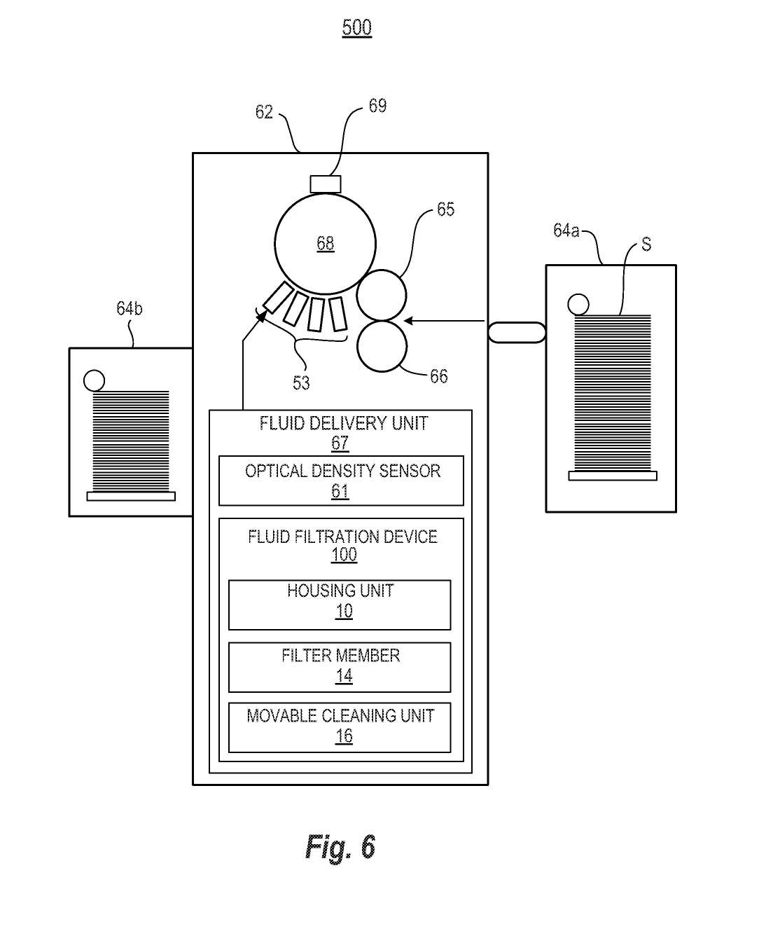

FIG. 6 is a schematic view illustrating an image forming system such as a liquid electrophotography printing apparatus including the fluid filtration device of FIG. 2 according to an example. Referring to FIG. 6, in some examples, the image forming system 500 such as a liquid electrophotography printing apparatus (LEP) may include an image forming unit 62, an input unit 64a and an output unit 64b. The image forming unit 62 may receive a substrate S from the input unit 64a and output the substrate S to the output unit 64b. The image forming unit 62 may include a photo imaging member (PIP) 68 and a fluid delivery unit 67. The photo imaging member (PIP) 68 includes an outer surface on which images can be formed. The outer surface may be charged with a suitable charger (not illustrated), such as a charge roller, and portions of the outer surface that correspond to features of the image can be selectively discharged by a laser writing unit 69 to form an electrostatic image on the outer surface.

Referring to FIG. 6, in some examples, the fluid delivery system 67 may supply fluid such as liquid toner, for example, ElectroInk, trademarked by Hewlett-Packard Company, having carrier oil mixed therein to fluid applicator units 53 of the LEP such as BIDs. The fluid delivery unit 67 may also include a fluid filtration device 100 (FIG. 1) to filter the fluid such as carrier oil and/or ink and an optical density sensor 61 to detect the density of the respective fluid. In some examples, the fluid filtration device 100 may filter the fluid to be provided to the optical density sensor 61. The fluid filtration device 100 may include a housing unit 10, a filter member 14 and a movable cleaning unit 16. The BIDs may apply the fluid to the electrostatic image to form an image on the outer surface of the PIP 68 to be transferred to an intermediate transfer member (ITM) 65. The ITM 65 may receive the image from the PIP 68, heat the image, and transfer the image to the substrate S. During the transfer from the ITM 65 to the substrate 5, the substrate S is pinched between the ITM 65 and an impression member 69. Thus, the image may be transferred to the substrate S which may be transported to the output unit 64b.

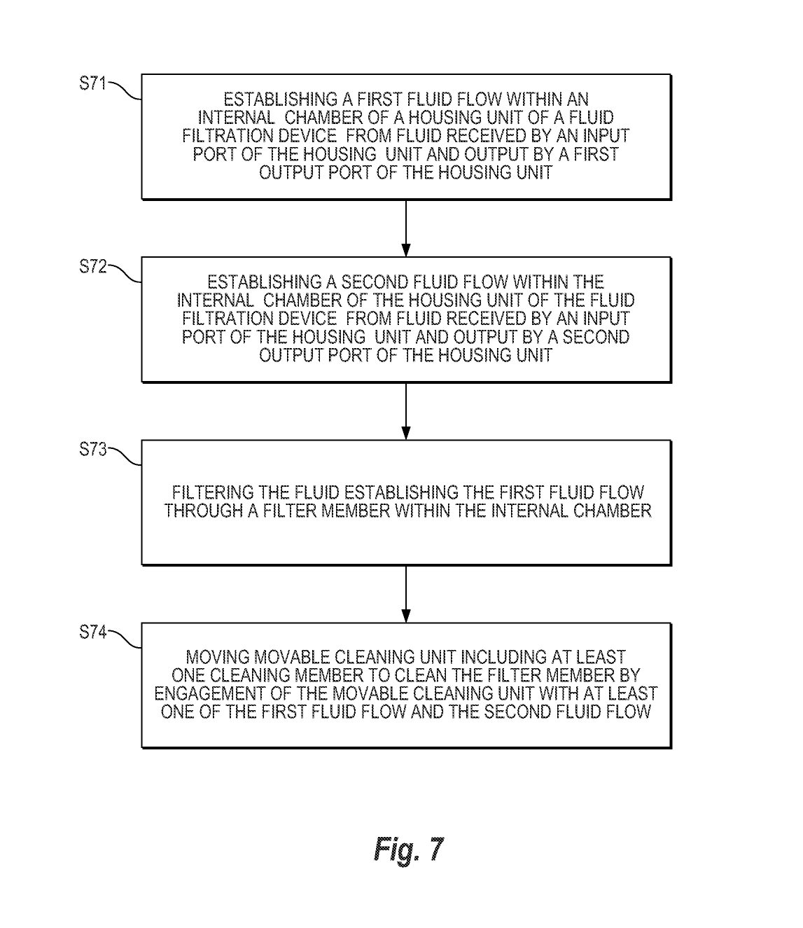

FIG. 7 is a flowchart illustrating a method of filtering fluid according to an example. Referring to FIG. 7, in block S71, a first fluid flow is established within an internal chamber of a housing unit of a fluid filtration device from fluid received by an input port of the housing unit and output by a first output port of the housing unit. In block S72, a second fluid flow is established within the internal chamber of the housing unit of the fluid filtration device from fluid received by the input port of the housing unit and output by a second output port of the housing unit. In block S73, the fluid establishing the first fluid flow is filtered through a filter member within the internal chamber. In S74, a movable cleaning unit including at least one cleaning member is moved to clean the filter member by engagement of the movable cleaning unit with at least one of the first fluid flow and the second fluid flow.

For example, the movable cleaning unit may be moved by the engagement with the first fluid flow and the second fluid flow. In some examples, the movable cleaning unit may be rotated to clean the filter member by the engagement with the at least one of the first fluid flow and the second fluid flow. Additionally, the movable cleaning unit may include a rotatable brush unit. For example, the at least one cleaning member may also include at least one brush member to brush the filter member in response to rotation of the rotatable brush unit by the engagement with the at least one of the first fluid flow and the second fluid flow. Further, the at least one brush member may include a plurality of brush members to brush the filter member in response to the rotation of the rotatable brush unit by the engagement of the at least one of the first fluid flow and the second fluid flow. The method may also include bypassing the filter member to establish the second fluid flow within the internal chamber.

It is to be understood that the flowchart of FIG. 7 illustrates an architecture, functionality, and operation of an example of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 7 illustrates a specific order of execution, the order of execution may differ from that which is depicted. For example, the order of execution of two or more blocks may be scrambled relative to the order illustrated. Also, two or more blocks illustrated in succession in FIG. 7 may be executed concurrently or with partial concurrence. All such variations are within the scope of the present disclosure.

The present disclosure has been described using non-limiting detailed descriptions of examples thereof that are not intended to limit the scope of the present disclosure. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the present disclosure and which are described for illustrative purposes. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A method of filtering fluid, comprising:
establishing a first fluid flow within an internal chamber of a housing unit of a fluid filtration device from fluid received by an input port of the housing unit and output by a first output port of the housing unit;
establishing a second fluid flow within the internal chamber of the housing unit of the fluid filtration device from fluid received by the input port of the housing unit and output by a second output port of the housing unit;
filtering the fluid establishing the first fluid flow through a filter member within the internal chamber; and
moving a movable cleaning unit including at least one cleaning member to clean the filter member by engagement of the movable cleaning unit with at least one of the first fluid flow and the second fluid flow.

2. The method according to claim 1, wherein the moving a movable cleaning unit including at least one cleaning member to clean the filter member by engagement of the movable cleaning unit with at least one of the first fluid flow and the second fluid flow further comprises:
moving the movable cleaning unit by the engagement with the first fluid flow and the second fluid flow.

3. The method according to claim 1, wherein the moving a movable cleaning unit including at least one cleaning member to clean the filter member by engagement of the movable cleaning unit with at least one of the first fluid flow and the second fluid flow further comprises:
rotating the movable cleaning unit to clean the filter member by the engagement with the at least one of the first fluid flow and the second fluid flow.

4. The method according to claim 1, wherein the movable cleaning unit comprises a rotatable brush unit.

5. The method according to claim 4, wherein the at least one cleaning member further comprises at least one brush member to brush the filter member in response to rotation of the rotatable brush unit by the engagement with the at least one of the first fluid flow and the second fluid flow.

6. The method according to claim 5, wherein the at least one brush member comprises a plurality of brush members to brush the filter member in response to the rotation of the rotatable brush unit by the engagement of the at least one of the first fluid flow and the second fluid flow.

7. The method according to claim 1, further comprising:
bypassing the filter member to establish the second fluid flow within the internal chamber.

8. A fluid filtration device, comprising:
a housing unit including an internal chamber, an input port, a first output port, and a second output port;
the input port to receive fluid into the internal chamber;
the first output port to output fluid from the internal chamber received by the input port to establish a first fluid flow therein; and
the second output port to output fluid from the internal chamber received by the input port to establish a second fluid flow therein;
a filter member disposed within the internal chamber to filter the fluid forming the first fluid flow; and
a movable cleaning unit including at least one cleaning member to clean the filter member in response to engagement of the movable cleaning unit with at least one of the first fluid flow and the second fluid flow.

9. The fluid filtration device according to claim 8, wherein the movable cleaning unit is configured to move by the engagement with the first fluid flow and the second fluid flow.

10. The fluid filtration device according to claim 9, wherein the movable cleaning unit comprises a rotatable brush unit configured to rotate in response to the engagement with the at least one of the first fluid flow and the second fluid flow.

11. The fluid filtration device according to claim 10, wherein the at least one cleaning member comprises at least one brush member to brush the filter member in response to rotation of the rotatable brush unit by the engagement with the at least one of the first fluid flow and the second fluid flow.

12. The fluid filtration device according to claim 11, wherein the at least one brush member comprises a plurality of brush members to brush the filter member in response to the rotation of the rotatable brush unit by the engagement of the first fluid flow and the second fluid flow.

13. The fluid filtration device according to claim 8, wherein the second outlet port is configured to establish the second fluid flow within the internal chamber by bypassing the filter member.

14. The fluid filtration device according to claim 8, wherein the filter member is disposed opposite to the first outlet port.

15. The fluid filtration device according to claim 8, wherein the movable cleaning unit is movable coupled to the filter member.

16. The fluid filtration device according to claim 8, wherein the housing unit further comprises:
a top wall including the second output port;
a bottom wall including the first outlet port, the bottom wall disposed across from and substantially parallel to the top wall; and
a side wall including the input port, the side wall connected and substantially perpendicular to the top wall and bottom wall.

17. The fluid filtration device according to claim 16, wherein the second output port is disposed at substantially a center of the top wall.

18. The fluid filtration device according to claim 16, wherein the first output port is disposed at substantially a center of the bottom wall.

19. The fluid filtration device according to claim 16, wherein the input port is disposed at the side wall in an asymmetrical manner.

20. An image forming system, comprising:
a fluid applicator unit to apply fluid to a substrate;
a fluid supply to supply the fluid to the fluid applicator unit; and
a fluid filtration device to filter the fluid supplied to the fluid applicator unit, the fluid filtration device including:
a housing unit including an internal chamber, an input port, a first output port, and a second output port;
the input port to receive the fluid into the internal chamber;
the first output port to output the fluid from the internal chamber received by the input port to the fluid applicator unit to establish a first fluid flow therein; and
the second output port to output the fluid from the internal chamber received by the input port to establish a second fluid flow therein;
a filter member disposed within the internal chamber to filter the fluid forming the first fluid flow; and
a rotatable brush unit including at least one brush member to brush the filter member in response to engagement of the rotatable brush unit with at least one of the first fluid flow and the second fluid flow.
